(19) United States
(12) Patent Application Publication
(10) Pub. No.: US 2011/0066608 A1
(43) Pub. Date: Mar. 17, 2011

(54) SYSTEMS AND METHODS FOR DELIVERING TARGETED CONTENT TO A USER

(75) Inventors: William W. Graham, JR., San Francisco, CA (US); Peter J. Offringa, San Francisco, CA (US)

(73) Assignee: CBS INTERACTIVE, INC., County of New Castle, DE (US)

(21) Appl. No.: 12/559,455

(22) Filed: Sep. 14, 2009

(51) Int. Cl. G06F 15/16; G06F 12/08; G06F 17/30

(52) U.S. Cl. 707/708; 709/203; 711/126; 707/E17.014; 711/E12.017; 707/771

(57) ABSTRACT

An architectural stack includes a rules proxy. The rules proxy may be between a web server and a HTTP proxy cache, and may be an HTTP proxy application. The rules proxy receives a user request to access a web page from the web server, captures user data (e.g., referrer data and/or session data) from the user request, applies a rule to the user data to assign the user to a user bucket, generates a web page with content using the assigned user bucket, and delivers the user-specific, generated web page to the user.

### BACKGROUND

1. Field

The subject invention relates to systems and methods for delivering content to a user.

2. Related Art

Users of the Internet access content from a variety of different websites. Conventionally, the web application that delivers a web page to the user is connected to memory that stores the content and business logic for the web page. Some websites separate the content and the business logic to generate the web page, allowing the web site to change its content more easily.

Some of these websites target advertisements to users based on information about the user. These websites typically require the user to create a user profile with relevant information about the user (e.g., the user's age, residence, interests and other identifying information). This information can then be used to deliver advertisements to users that meet certain criteria.

Search engines also sometimes track user's interactions with search results to try to deliver better search results to users. These search engines, however, are not typically able to target specific users. Instead, the search engines tend to use the user's behavior to tailor search results for future users who perform the same search.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a computer-implemented method is provided that includes receiving a user request to access a web page; capturing user data from the user request, the user data selected from the group consisting of referrer data, session data and combinations thereof; applying a rule to the user data to assign a user associated with the user request to a user bucket; accessing a cache in real time to identify content responsive to the user request based on the assigned user bucket; generating a response to the user request using the identified content; and transmitting the generated response to the user.

According to a further aspect of the invention, a computer-readable storage media is provided having computer executable instructions stored thereon which cause a computer system to carry out a method when executed, the method including receiving a user request to access a web page; capturing user data from the user request, the user data selected from the group consisting of referrer data, session data and combinations thereof; applying a rule to the user data to assign a user associated with the user request to a user bucket; accessing a cache in real time to identify content responsive to the user request based on the assigned user bucket; generating a response to the user request using the identified content; and transmitting the generated response to the user.

Generating the response to the user request based on the assigned user bucket may include identifying an advertisement to deliver to the user based on the assigned user bucket.

The method may also include applying a plurality of rules to the user data to assign the user to a plurality of user buckets, and wherein generating the response to the user may be based on at least one of the plurality of user buckets.

The cache may include content periodically updated from an application programming interface.

The response may be generated in real time.

The response may include a plurality of different content types identified based on the assigned user bucket.

A type of content used to generate the response may be determined based on the assigned user bucket.

The user data may include at least one of referrer information and session information.

The referrer information may be selected from the group consisting of referring website and search terms, and wherein the session information may be selected from the group consisting of number of pages clicked, the user's interaction with the content and amount of time the user was on a web site associated with the web page.

The method may also include assigning the user to a plurality of user buckets.

According to another aspect of the invention, a computer system is provided that includes memory; and a processor coupled to the memory, the processor configured to receive a user request to access a web page; capture user data from the user request, the user data selected from the group consisting of referrer data, session data and combinations thereof; apply a rule to the user data to assign a user associated with the user request to a user bucket; access a cache in real time to identify content responsive to the user request based on the assigned user bucket; generate a response to the user request using the identified content; and transmit the generated response to the user.

The processor may be further configured to apply a plurality of rules to the user data to assign the user to a plurality of user buckets, and wherein generating the response to the user is based on at least one of the plurality of user buckets.

The processor may be further configured to assign the user to a plurality of user buckets.

According to a further aspect of the invention, a computer system is provided that includes a web server configured to receive a page request from a user and deliver a page to the user in response to the page request; a rules proxy in communication with a real-time session server and the web server, the rules proxy configured to assign the user to a user segment group based on the page request; a cache in communication with the rules proxy; and a data store in communication with the cache, the data store comprising content for the page, wherein the content is assigned to at least one of a plurality of user segment groups.

The system may also include a site application in communication with the cache; and a data application programming interface (API) in communication with the site application and the data store.

The system may also include a rules data store configured to store rules that the rules proxy uses to assign the user to a user segment group.

The system may also include an advertisement server coupled to the real-time session server and the web server, the advertisement server configured to identify an advertisement to deliver to the web server to be included in the page using data stored in the real-time session server.

The data store in communication with cache may include a plurality of data stores in communication with the cache.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of a network system according to one embodiment of the invention;

FIG. 2 is a block diagram of an exemplary system architecture according to one embodiment of the invention;

FIG. 3 is a detailed block diagram of the rules proxy according to one embodiment of the invention;

FIG. 4 is a flow diagram for a process for delivering targeted content to a user according to one embodiment of the invention;

FIG. 5 is a flow diagram for a detailed process for delivering targeted content to a user according to one embodiment of the invention;

FIG. 6 is a flow diagram for a detailed process for assigning a unique identifier to a user according to one embodiment of the invention; and

FIG. 7 is a block diagram of an exemplary computer system according to one embodiment of the invention.

### DETAILED DESCRIPTION

Embodiments of the invention relate to an architectural stack includes an asset real-time recommendation and optimization web proxy (ARROW, “Arrow” hereinafter) between a web server and a HTTP proxy cache. Arrow is a rules proxy. Arrow can be used to track a user's behavior as the user browses web properties on a web site. From the behavioral data collected, Arrow can determine the content that interests a particular user by running a set of rules using the user's behavior information when a page request is received. Based on the user's interests, Arrow can assign the user to one or more user segment groups or user buckets. The site applications can then use the user segment information to customize the web page based on the user's interests (e.g., serve targeted content and/or advertisements).

In one embodiment, Arrow is an HTTP proxy application that receives a user request to access a web page from the web server, captures user data (e.g., referrer data and/or session data) from the user request, applies a rule to the user data to assign the user to a user bucket(s), generates a web page with content using the assigned user bucket(s), and delivers the user-specific, generated web page to the user.

Advantages of embodiments of the invention include the ability to learn from a user's behavior in real-time (i.e., in the user's current browsing session). This allows the best possible content to be served to a given user. In addition, the rules can be programmed so that the user segment information can be used for a variety of applications. For example, Arrow can be used to determine that a user is interested in anti-virus software on download.com, but has not yet downloaded anything; targeted run-of-site ads can be sold to anti-virus companies for a larger premium for these users. In another example, Arrow can be used to determine that a user came to the site after searching for a given product on a search engine, such as google; targeted ads can be sold for competitor's products to these types of users. In yet another example, the user experience can be personalized by recognizing that a user favors one site over another, and populating navigational elements accordingly. From how the user arrived on the site, Arrow can determine that they might be less inclined to turn multiple pages than another user, which can be used to swap a page component that tends to drive user-engagement with another page component that drives more revenue. Arrow can also be used to perform multivariate testing to track which multivariate test groups the user is in, add the user to a new group if a new test is running, and the like.

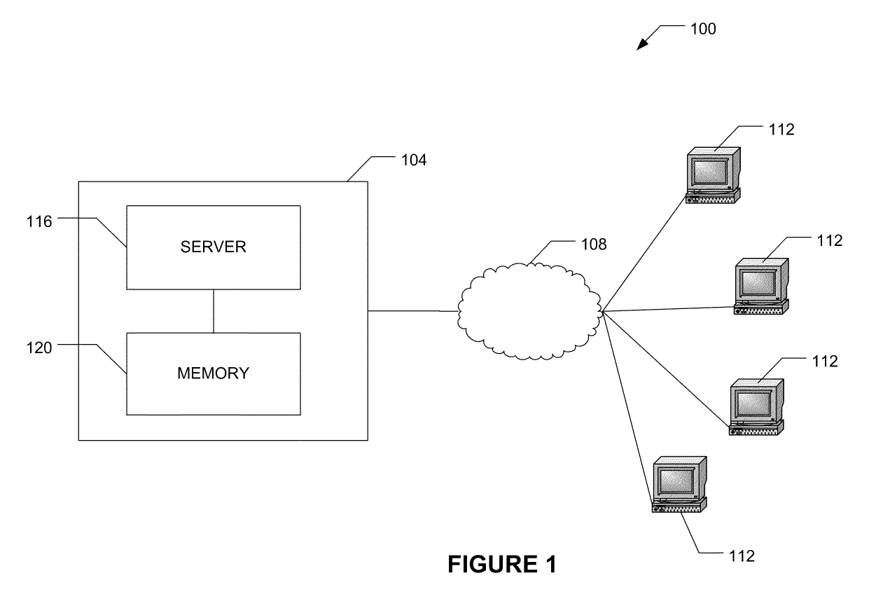

An embodiment of the invention will now be described in detail with reference to FIG. 1. FIG. 1 illustrates a web-based system 100 for delivering content to a user. The system 100 includes a host site 104 and a plurality of user systems 112 coupled via a network 108. The system 104 includes a server 116 and memory 120.

The host site 104 is connected to the plurality of user systems 112 over the network 108. The server 116 is in communication with the memory 120. The system 104 is typically a computer system, and may be an HTTP (Hypertext Transfer Protocol) server (e.g., an Apache server). The memory 120 includes storage media, which may be volatile or non-volatile memory that includes, for example, read only memory (ROM), random access memory (RAM), magnetic disk storage media, optical storage media, flash memory devices and zip drives.

The network 108 is a local area network (LAN), wide area network (WAN), a telephone network, such as the Public Switched Telephone Network (PSTN), an intranet, the Internet, or combinations thereof. The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers.

When a user of one of the plurality of user systems 112 requests to access the server to view search results responsive to a search query, a request is communicated to the host site 104 over the network 108. For example, a signal is transmitted from one of the user systems 112, the signal having a destination address (e.g., address representing the search results page for the web site), a request (e.g., a request to view the requested page) and a return address (e.g., address representing user system that initiated the request). The request may include a cookie that includes data identifying the user and/or the user computer. The server 116 accesses the database 120 to provide the user with the requested web page, which is communicated to the user over the network 108. For example, another signal may be transmitted that includes a destination address corresponding to the return address of the client system, and a web page responsive to the request.

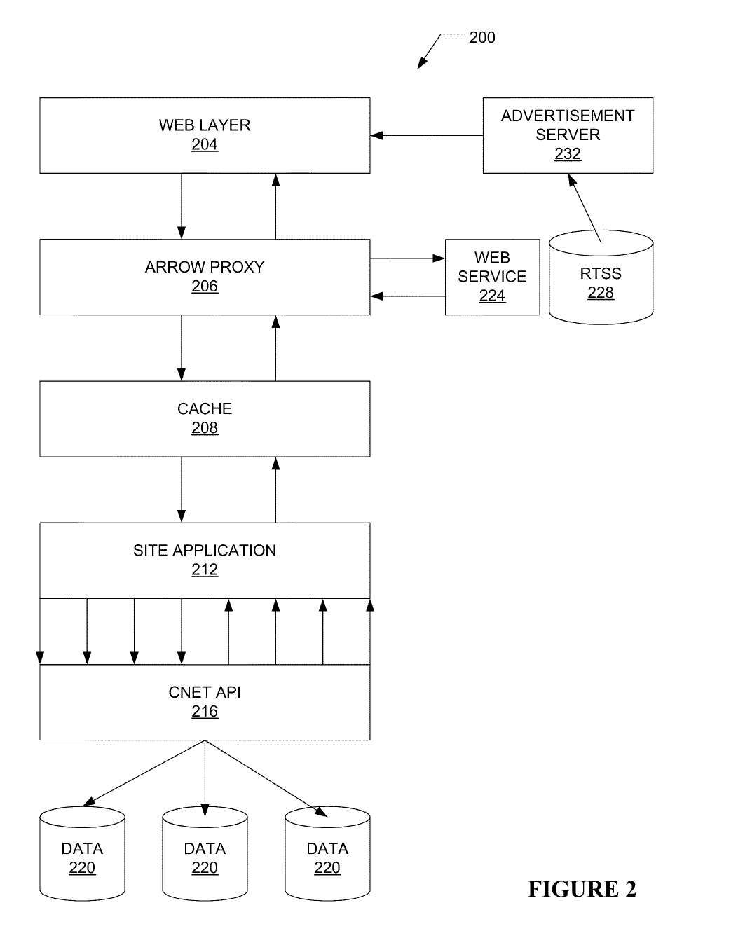

FIG. 2 illustrates an exemplary system architecture 200 at the server 104 according to one embodiment of the invention. It will be appreciated that the system architecture may be implemented as one server (e.g., server 104) or a plurality of servers in communication with one another.

As shown in FIG. 2, the system architecture 200 includes a web layer 204 (or web server), an arrow proxy 206, a cache 208, a site application 212, a data API (application programming interface) 216 and a plurality of data stores 220. The arrow proxy 206 is in communication with a web service 224 that is coupled to a real-time session store (RTSS) 228. An advertisement server 232 may also be in communication with the web layer 204 and the RTSS 228. It will be appreciated that the system architecture may vary from the illustrated architecture. For example, the web layer 204 may directly access the API 216 which accesses data stores 220, the system architecture 200 may not include the cache 208, etc., as will be appreciated by those skilled in the art.

The web layer 204 is configured to receive user requests to access content through a web browser and return content that is responsive to the user request. The web layer 204 communicates the user requests to the cache 208. In one embodiment, the web layer 204 is an Apache server.

The cache 208 is configured to temporarily store content that is accessed frequently by the web layer 204 and can be rapidly accessed by the web layer 204. In one embodiment, the cache 208 may be a caching proxy server. The cache 208 communicates the user requests to the site application 212.

The site application 212 is configured to update the cache 208 and to process user requests received from the web layer 204. The site application 212 may identify that the user request is for a page that includes data from multiple sources. The site application 212 can then convert the page request into a request for content from multiple sources and transmits these requests to the site API 216. The site application 212 may also include business logic that determines, for example, how to decorate the web page, the layout of the web page, components of the web page, and the like.

The data API 216 is configured to simultaneously access data from the plurality of data stores 220 to collect the data responsive to the plurality of requests from the site application 212. The plurality of data stores 220 include data about different sites owned by a company (e.g., download.com, cnet.com, tv.com, etc. owned by CBS Interactive) or are otherwise related.

The data in the data stores 220 is provided to the data API 216, which provides the content to the site application 212. The site application 212 updates the cache 208 and delivers the cached content in combination with the accessed content to the web layer 204, which delivers browsable content to the user.

The arrow proxy 206 may be an HTTP proxy server. The arrow proxy 206 uses a rules-based approach to determine user session data that should be stored and read and determines how to bucket a user into a user segment. Because the arrow proxy 206 is implemented as an HTTP proxy it can sit outside the cache 208, which allows the arrow proxy 206 to collect user behavior data for pages that are served from the cache 208. If a user is bucketed in a given user segment, the bucket information is included in the cache key.

When the arrow proxy 206 receives an HTTP request, the arrow proxy 206 captures referrer data, reads previous session data, runs bucketing rules, proxy requests to the site application server and writes additional session data. For example, the arrow proxy 206 may capture referrer data by reading the HTTP “REFERER” header to determine whether the user request originated on a third party site. If so and if the site was a search engine, the hostname and search terms are bound to the user's session. The arrow proxy 206 may read previous session data by checking for any previously stored session data bound to the user (e.g., from the RTSS 228). It will be appreciated that although the RTSS 228 in FIG. 2 is used to store the user data, any key-based data store may be used to store the user data. If previous session data is found, it is bound to the user.

When the arrow proxy 206 runs bucketing rules, the arrow proxy 206 looks up the rules configured for this URI path. If any rules are found, the rules are run on the user (i.e., on the user data). The end condition of a successful rule set typically involves adding a user to a given user segment, or bucket. The arrow proxy 206 may proxy requests to the site application 212 by adding the bucket information to the HTTP request before proxying the request to the downstream site application 212. The site application 212 can then process the request as it normally would, with the user bucket data at its disposal. This allows the site application 212 to cater the content it serves based on the user bucket that a user belongs to.

The arrow proxy 206 is also used after the site application 212 handles the request. The arrow proxy 206 then runs another set of rules to determine what session data to persist in the session data store (RTSS in this case). It will be appreciated that in one embodiment the request to persist the additional data may be made asynchronously as the optimized page is being served to the end user, so as to not have a noticeable impact on page-load time. Exemplary data includes a page, URL, category, site, referring site, referrer search terms and the like.

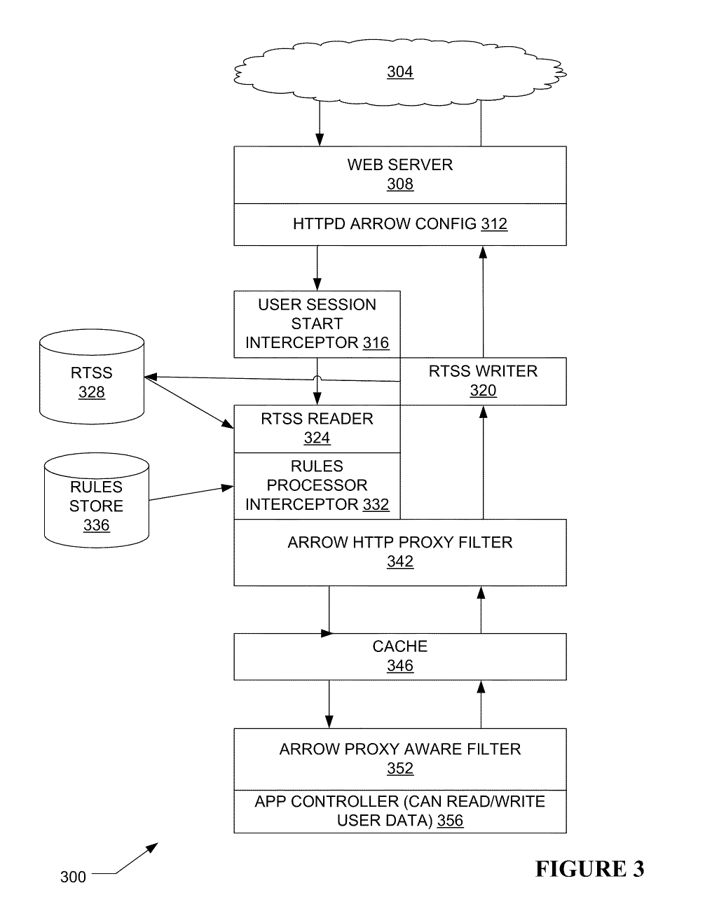

FIG. 3 illustrates a detailed view of an exemplary architecture 300 that includes the arrow proxy 206. As shown in FIG. 3, user requests 304 are received at the web server 308, which is communication with the HTTPD arrow config 312. The HTTPD arrow config 312 is in communication with the user session start interceptor 316. An RTSS writer 320 is also in communication with the HTTPD arrow config 312, and the user session start interceptor 316 is in communication with an RTSS reader 324. The RTSS reader 324 reads content from the RTSS 328 and the RTSS writer 320 writes content to the RTSS 328. The RTSS reader 324 is also in communication with the rules processor interceptor 332 which accesses rules in the rules store 336. The rules processor interceptor 332 is in communication with the arrow http proxy filter 342, which is in communication with the cache 346. The cache 346 is in communication with the arrow proxy aware filter 352 which is communication with the app controller 356. The arrow HTTP proxy filter 352 is also in communication with the RTSS writer 320.

As described above, the arrow proxy 206 is a webapp that sits outside the outermost HTTP page caching tiers to provide the arrow proxy functionality that occurs even when a cached page is returned. In addition to proxying the request to another server tier for handling, the arrow proxy serves three primary functions: reading user RTSS data to determine if the user belongs to one or more interest groups, and, if so, including this data as an HTTP request header for use by downstream handlers; writing bulk RTSS data to track the browsing activity of our users even when the user is served a cached page; and generating a temporary session id if no DW session id is found for RTSS use (if both are found, the arrow proxy 206 does an RTSS merge of the data to the DW session id). It will be appreciated that most of the functionality provided by the arrow proxy can be integrated directly into the page-generating webapp as described below.

Arrow provides a framework for webapp developers to easily set and retrieve user personalization data using RTSS. By including one or more of the Arrow interceptors or taglibs, webapp developers can read RTSS data for a given user, bulk-set RTSS user history data, or set and get specific RTSS data for a given use case.

HTTPD arrow config 312 (referrer header information) runs on the web server and writes referrer information into headers for use by the arrow proxy. The httpd-arrow-config 312 parses the referrer header to extract the external referrer host and search string. This data is set as HTTP headers for downstream applications to consume and as environment values fields for consumption. In one embodiment, the values are only set if the referrer is from a search engine, such as google or yahoo. Exemplary variables include REFERER-HOST and REFERER-SEARCH-TERMS. Exemplary HTTP headers include X-REFERER-HOST and X-REFERER-SEARCH-TERMS.

The user session start interceptor 316 runs on the arrow proxy and looks for referrer information in the header and writes it to the user object. The user session start interceptor 316 initializes a few values for the arrow system to use. Mainly, the user session start interceptor 316 reacts to the headers set in the httpd-arrow-config config files. The user session start interceptor 316 looks for headers that communicate the following exemplary information via header: the referrer URL, the referrer domain and the referrer search term. If found, this information is stored in the user object and passed on to the next interceptor.

The RTSS reader interceptor 324 runs before the request is proxied downstream. The RTSS reader interceptor 324 reads information from the RTSS 328 that is pertinent to the user and stores it in the user object. The RTSS reader interceptor 324 runs before the request is proxied to the downstream server, and queries the RTSS 328 for any data stored for the current user. The RTSS reader interceptor 324 can be configured to run and get either all or some subset of the user data for each user it encounters. If the RTSS reader interceptor 324 comes across any user data, it stores that data into the user object for later modules to access. Examples of the types of data the RTSS reader interceptor 324 pulls include a user's browsing history, past search terms, user bucket information for multivariate testing, and the like.

The RTSS writer interceptor 320 runs after the request has completed, operates on the user object and stores unsaved data (asynchronously) from the user object to the RTSS 328 before returning the response. The RTSS writer interceptor 320 is an interceptor that runs after the request has completed. The RTSS writer interceptor 320 inspects the user object and looks for values that are marked as needing to be persisted in the RTSS 328 and then asynchronously sends queued RTSS requests to store that data. Examples of the types of data the RTSS reader interceptor 324 stores in the RTSS 328 a user's browsing history, past search terms, user bucket information for multivariate testing, and the like.

The rules processor interceptor 332 can be configured to operate on any object. The rules processor interceptor 332 is a simple rules processing engine that inspects and conditionally mutates an object passed to it. The rules processor interceptor 332 is configured with a collection of rules and conditions which both conform to a component interface and are stored in the rules store 336. In one embodiment, the component interface has an execute method which results in a positive or negative result. These components can be configured to have a positiveNextStep or a negativeNextStep each of which also conforms to the component interface. Since actions and conditions both conform to the same interface, the rules processor interceptor 332 can generically nest any combination of conditions and actions. The rules processor interceptor 332 is typically configured to operate on (and modify) the user object.

The Arrow HTTP proxy filter 342 runs before the request is proxied downstream and again after the response returns. Before proxying downstream, the Arrow HTTP proxy filter 342 serializes important information from the user object to headers for reading by the proxy aware filter 352. After receiving the response from the proxy aware filter 352, the Arrow HTTP proxy filter 342 de-serializes header information into the user object so that it may be detected and saved to the RTSS 328 by the RTSS writer 320.

The Arrow HTTP proxy filter 342 is run on the Arrow Proxy before passing the request on to the downstream server, and receives the response back from the downstream app. Before the Arrow HTTP proxy filter 342 passes the request downstream, the Arrow HTTP proxy filter 342 can inspect the user object to set certain HTTP headers into the request. Exemplary headers include the X-USER-RTSS-DATA and X-USER-BUCKET. For every RTSS name/value pair of data bound to the user, the X-USER-RTSS-DATA header is set, allowing downstream applications to access the user's RTSS data. The X-USER-BUCKET is a token that signifies the additional application state that is not represented in the URL, which can be used by the cache 346 to distinguish different HTML versions of the same page. The arrow proxy aware filter 352 may need to vary on the X-USER-BUCKET, which is set by the proxy filter 342. In particular, the arrow proxy aware filter 352 tells the cache 346 to vary on it when it responds. After proxying to the downstream app(s), when the Arrow HTTP proxy filter 342 receives a response from downstream, it looks in the response for headers of a specific format. Any headers that match this format are de-serialized and set into the user object, and are persisted in the RTSS 328 by the RTSS writer 320.

The RTSS writer 320 writes common request data to the RTSS 328 for each pageview and can be configured to run for a given set of page types. The RTSS writer 320 may be used to write to the RTSS 328 on an every request basis. For example, a log of a users browsing history may be used by the RTSS writer 320.

The Arrow HTTP proxy aware filter 352 de-serializes header information and stores it in the user object when a request is received and serializes data that has been written into the user object into headers for the arrow proxy to persist in the RTSS 328. The Arrow HTTP proxy aware filter 352 is one of the first components to run on an appserver downstream from the arrow proxy, and is also one of the last components to run on the downstream application server before returning the request to the arrow proxy. Before the application processes the request, when the Arrow HTTP proxy aware filter 352 receives a request from the upstream server, the Arrow HTTP proxy aware filter 352 first looks for arrow headers coming from the upstream app, and ingests their data into a user object that can be conveniently used by the controller 356 or JSPs that rely on those headers for their features to work After the request is processed, the Arrow HTTP proxy aware filter 352 inspects the user object in its request and looks for variables that have been set into the user object and serializes them into response headers that the Arrow HTTP proxy aware filter 352 knows how to read and knows are meant to be stored in the RTSS 328. An exemplary header that can be used to store this information is X-RTSS-PERSIST. The X-RTSS-PERSIST header can contain any number of name value pairs that correlate to values that can be set on the user object. When these are set on the response by the Arrow HTTP proxy aware filter 352, these values will be stored in the RTSS 328.

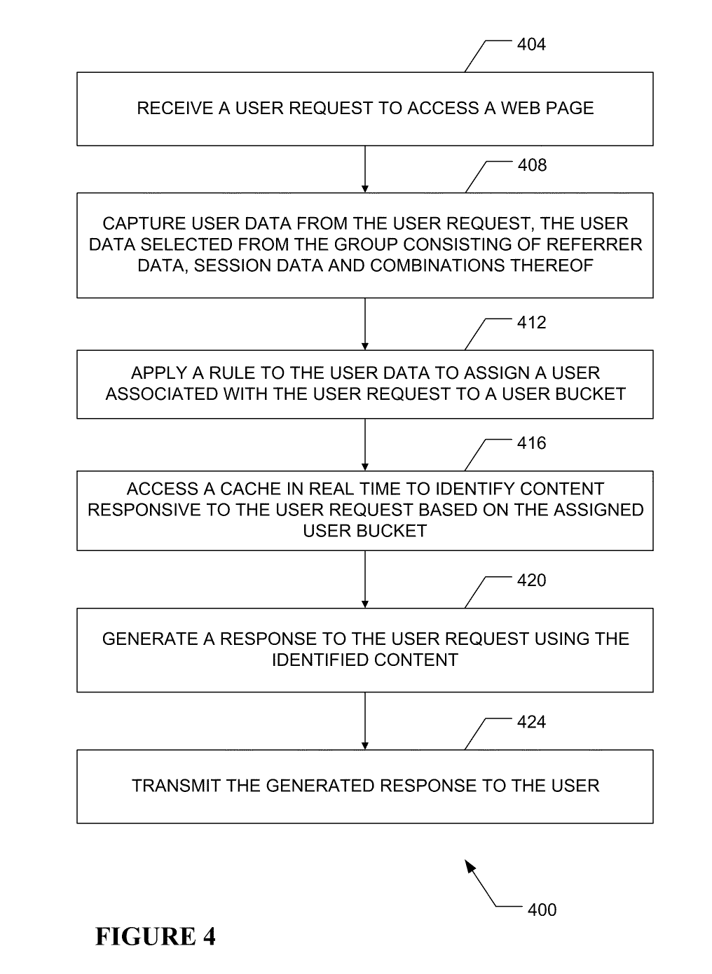

FIG. 4 illustrates a process for collecting data that can be used to target web pages based on the page request 400. It will be appreciated that the process 400 described below is merely exemplary and may include a fewer or greater number of steps, and that the order of at least some of the steps may vary from that described below.

The process 400 begins by receiving a user request to access a web page (block 404). For example, a user may request to access a download.com page.

The process 400 continues by capturing user data from the user request, the user data selected from the group consisting of referrer data, session data and combinations thereof (block 408). Types of data about the user include page, URL, category, site, referrer site and referrer terms.

The process 400 continues by applying a rule to the user data to assign a user associated with the user request to a user bucket (block 412). It will be appreciated that a user may be assigned to multiple user buckets. It will also be appreciated that more than on rule (i.e., a set of rules) may be applied to the user data to assign the user to the one or more user buckets. The rule may apply a flag or threshold value that indicates that a user is a member of the user segment or bucket.

The process 400 continues by accessing a cache in real time to identify content responsive to the user request based on the assigned user bucket (block 416). It will be appreciated that the content used to generate a response for the user may be accessed directly from the cache; alternatively, the content may be accessed indirectly from the cache (i.e., from the cache and through the site application, data API and/or data stores).

The process 400 continues by generating a response to the user request using the identified content (block 420). The response includes targeted content based on the user's user bucket. For example, the web page may include several page components and one or more of the page components may include content selected based on the user's assigned user bucket. The process 400 continues by transmitting the generated response to the user (block 424).

For example, a user may perform a Google search for McAfee antivirus software. The user may then select a search result that refers the user to the download.com website which provides users with the ability to download antivirus software. The user will then be bucketed into a group associated with downloading antivirus software. The user may be returned a web page that includes advertisements that relate to antivirus software that competes with McAfee antivirus software. If a user were to download antivirus software, the user would then be bucketed into a group that has already downloaded antivirus software. The user could then be targeted with different advertisements related to the website (e.g., an advertisement for tv.com, another website owned by CBS Interactive, or an advertisement for a television show on CBS).

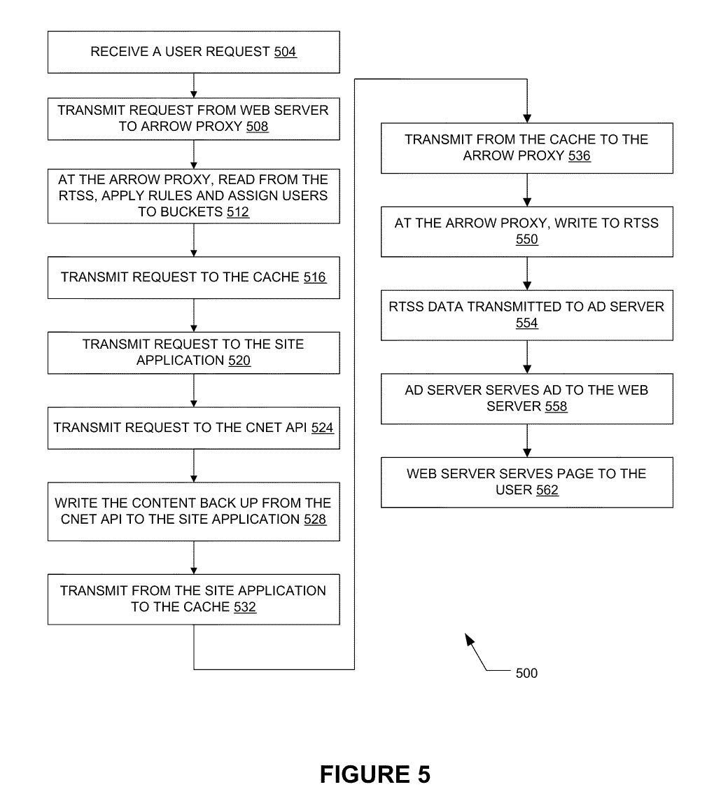

FIG. 5 illustrates a detailed process 500 for delivering a page in response to a page request using the architecture stack illustrated in FIG. 2. It will be appreciated that the process 500 described below is merely exemplary and may include a fewer or greater number of steps, and that the order of at least some of the steps may vary from that described below.

As shown in FIG. 5, the process 500 begins by receiving a user request (block 504). The process 500 continues by transmitting the request from the web server to the arrow proxy (block 508). The process 500 continues by, at the arrow proxy, reading from the RTSS, applying rules and assigning users to buckets (block 512).

The process 500 continues by transmitting the request to the cache (block 516), transmitting the request to the site application (block 520), and transmitting the request to the data API (block 524).

The process 500 continues by writing the content back up from the data API to the site application (block 528), transmitting the content from the site application to the cache (block 532), and transmitting the content from the cache to the arrow proxy (block 536).

The process 500 continues by, at the arrow proxy, writing to the RTSS (block 550). The process 500 continues by transmitting RTSS data to the ad server (block 554). The process 500 continues by the ad server serving an ad to the web server (block 558). The process 500 continues by the web server serving a page to the user (block 562).

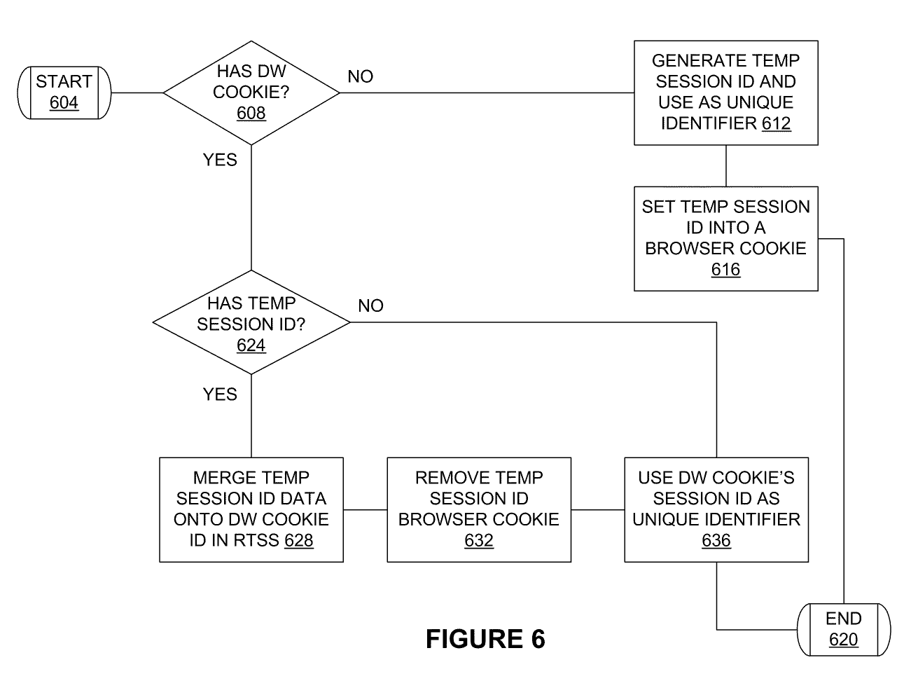

FIG. 6 illustrates an exemplary process 600 for assigning a user an identifier. It will be appreciated that the process 600 described below is merely exemplary and may include a fewer or greater number of steps, and that the order of at least some of the steps may vary from that described below.

As shown in FIG. 6, the process 600 starts 604 by determining whether the user has a DW cookie (block 608). If no, the process 600 continues by generating a temporary session id to which any information of interest may be attached (block 612). The process 600 continues by setting the temporary session id into a browser cookie (block 616) and the process ends 620. This value will be available again on their next request (i.e., using the DW cookie).

At block 608, if yes, the process continues by determining whether the user has a temporary session id (block 624). If yes, the process 600 continues by merging the temp session id data onto the DW cookie id in RTSS (block 628), removing the temp session id browser cookie (block 632) and using the DW cookie's session id as the unique identifier (block 636) before ending 620. After the first user visit, the DW cookie id can be used as the users' unique identifier. In order to keep the information gathered on their first hit, the data from the temp session id is merged with the DW cookie data and associated with the DW cookie id in RTSS. The record linked to the temporary session id is then deleted. This is commonly referred to as an RTSS merge. If no, the process continues to block 636 before ending 620.

It will be appreciated that, in the above process 600, the DW session id may be set by an external system and is accessible by the arrow proxy 206 upon the user's second page view. The arrow proxy 206 sets/removes the temp session id as needed but may not set the DW cookie id.

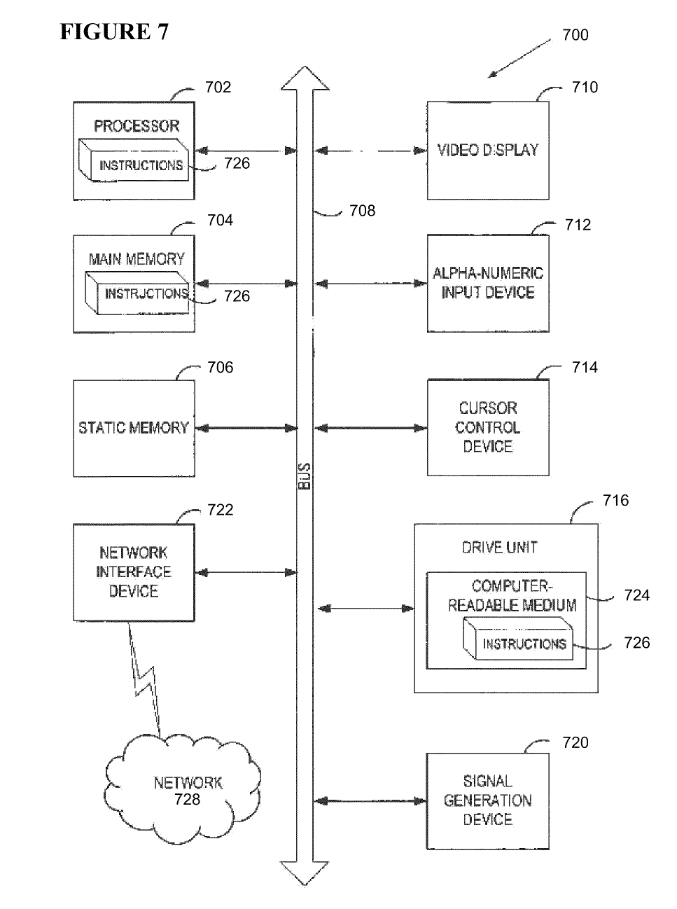

FIG. 7 shows a diagrammatic representation of machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU), a graphics processing unit (GPU) or both), a main memory 704 (e.g., read only memory (ROM), flash memory, dynamic random access memory (DRAM) such as synchronous DRAM (SDRAM) or Rambus DRAM (RDRAM), etc.) and a static memory 706 (e.g., flash memory, static random access memory (SRAM), etc.), which communicate with each other via a bus 708.

The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 720 (e.g., a speaker) and a network interface device 722.

The disk drive unit 716 includes a computer-readable medium 724 on which is stored one or more sets of instructions (e.g., software 726) embodying any one or more of the methodologies or functions described herein. The software 726 may also reside, completely or at least partially, within the main memory 704 and/or within the processor 702 during execution thereof by the computer system 700, the main memory 704 and the processor 702 also constituting computer-readable media. The software 726 may further be transmitted or received over a network 728 via the network interface device 722.

While the computer-readable medium 724 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It should be noted that the server is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method comprising:
receiving a user request to access a web page;
capturing user data from the user request, the user data selected from the group consisting of referrer data, session data and combinations thereof;
applying a rule to the user data to assign a user associated with the user request to a user bucket;
accessing a cache in real time to identify content responsive to the user request based on the assigned user bucket;
generating a response to the user request using the identified content; and
transmitting the generated response to the user.

2. The computer-implemented method of claim 1, wherein generating the response to the user request based on the assigned user bucket comprises identifying an advertisement to deliver to the user based on the assigned user bucket.

3. The computer-implemented method of claim 1, further comprising applying a plurality of rules to the user data to assign the user to a plurality of user buckets, and wherein generating the response to the user is based on at least one of the plurality of user buckets.

4. The computer-implemented method of claim 1, wherein the cache comprises content periodically updated from an application programming interface.

5. The computer-implemented method of claim 1, wherein the response is generated in real time.

6. The computer-implemented method of claim 1, wherein the response comprises a plurality of different content types identified based on the assigned user bucket.

7. The computer-implemented method of claim 1, wherein a type of content used to generate the response is determined based on the assigned user bucket.

8. The computer-implemented method of claim 1, wherein the user data comprises at least one of referrer information and session information.

9. The computer-implemented method of claim 1, wherein the referrer information is selected from the group consisting of referring website and search terms, and wherein the session information is selected from the group consisting of number of pages clicked, the user's interaction with the content and amount of time the user was on a web site associated with the web page.

10. The computer-implemented method of claim 1, further comprising assigning the user to a plurality of user buckets.

11. A computer-readable storage media having computer executable instructions stored thereon which cause a computer system to carry out a method when executed, the method comprising:
receiving a user request to access a web page;
capturing user data from the user request, the user data selected from the group consisting of referrer data, session data and combinations thereof;
applying a rule to the user data to assign a user associated with the user request to a user bucket;
accessing a cache in real time to identify content responsive to the user request based on the assigned user bucket;
generating a response to the user request using the identified content; and
transmitting the generated response to the user.

12. The computer-readable storage media of claim 11, wherein generating the response to the user request based on the assigned user bucket comprises identifying an advertisement to deliver to the user based on the assigned user bucket.

13. The computer-readable storage media of claim 11, further comprising applying a plurality of rules to the user data to assign the user to a plurality of user buckets, and wherein generating the response to the user is based on at least one of the plurality of user buckets.

14. The computer-readable storage media of claim 11, wherein the cache comprises content periodically updated from an application programming interface.

15. The computer-readable storage media of claim 11, wherein the response is generated in real time.

16. The computer-readable storage media of claim 11, wherein the response comprises a plurality of different content types identified based on the assigned user bucket.

17. The computer-readable storage media of claim 11, wherein a type of content used to generate the response is determined based on the assigned user bucket.

18. The computer-readable storage media of claim 11, wherein the user data comprises at least one of referrer information and session information.

19. The computer-readable storage media of claim 11, wherein the referrer information is selected from the group consisting of referring website and search terms, and wherein the session information is selected from the group consisting of number of pages clicked, the user's interaction with the content and amount of time the user was on a web site associated with the web page.

20. The computer-readable storage media of claim 11, further comprising assigning the user to a plurality of user buckets.

21. A computer system comprising:
memory; and
a processor coupled to the memory, the processor configured to receive a user request to access a web page; capture user data from the user request, the user data selected from the group consisting of referrer data, session data and combinations thereof; apply a rule to the user data to assign a user associated with the user request to a user bucket; access a cache in real time to identify content responsive to the user request based on the assigned user bucket; generate a response to the user request using the identified content; and transmit the generated response to the user.

22. The computer system of claim 21, wherein the processor is further configured to apply a plurality of rules to the user data to assign the user to a plurality of user buckets, and wherein generating the response to the user is based on at least one of the plurality of user buckets.

23. The computer system of claim 21, wherein the processor is further configured to assign the user to a plurality of user buckets.

24. A computer system comprising:
a web server configured to receive a page request from a user and deliver a page to the user in response to the page request;
a rules proxy in communication with a real-time session server and the web server, the rules proxy configured to assign the user to a user segment group based on the page request;
a cache in communication with the arrow proxy; and
a data store in communication with the cache, the data store comprising content for the page, wherein the content is assigned to at least one of a plurality of user segment groups.

25. The computer system of claim 24, further comprising
a site application in communication with the cache; and
a data application programming interface (API) in communication with the site application and the data store.

26. The computer system of claim 24, further comprising a rules data store configured to store rules that the rules proxy uses to assign the user to a user segment group.

27. The computer system of claim 24, further comprising an advertisement server coupled to the real-time session server and the web server, the advertisement server configured to identify an advertisement to deliver to the web server to be included in the page using data stored in the real-time session server.

28. The computer system of claim 24, wherein the data store in communication with cache comprises a plurality of data stores in communication with the cache.
